(19) United States
(12) Patent Application Publication
(10) Pub. No.: US 2024/0202538 A1
(43) Pub. Date: Jun. 20, 2024

(54) SYSTEM DESIGN FOR AN INTEGRATED LIFELONG MACHINE LEARNING AGENT

(71) Applicant: SRI International, Menlo Park, CA (US)

(72) Inventors: Aswin NADAMUNI RAGHAVAN, Pennington, NJ (US); Indranil SUR, Plainsboro, NJ (US); Zachary DANIELS, Robbinsville, NJ (US); Jesse HOSTETLER, Boulder, CO (US); Abrar RAHMAN, Brooklyn, NY (US); Ajay DIVAKARAN, Monmouth Junction, NJ (US); Michael R. PIACENTINO, Southern Shores, NC (US)

(21) Appl. No.: 18/535,928

(22) Filed: Dec. 11, 2023

Related U.S. Application Data
(60) Provisional application No. 63/431,914, filed on Dec. 12, 2022.

(51) Int. Cl. G06N 3/092

(52) U.S. Cl. CPC G06N 3/092

(57) ABSTRACT

A method, apparatus and system for lifelong reinforcement learning include receiving features of a task, communicating the task features to a learning system, where the learning system learns or performs a task related to the features based on learning or performing similar previous tasks, determining from the features if the task has changed and if so, communicating the features of the changed task to the learning system, where the learning system learns or performs the changed task based on learning or performing similar previous tasks, automatically annotating feature characteristics of received features including differences between the features of the original task and the features of the changed task to enable the learning system to more efficiently learn or perform at least the changed task, and if the task has not changed, processing the task features of a current task by the learning system to learn or perform the current task.

### CROSS-REFERENCE TO RELATED APPLICATIONS

This application claims priority to and benefit of U.S. Provisional Patent Application Ser. No. 63/431,914 filed Dec. 12, 2022, which is herein incorporated by reference in its entirety.

### GOVERNMENT RIGHTS

This invention was made with Government support under contract number HR0011-18-C-0051 awarded by the Defense Advanced Research Projects Agency (DARPA). The Government has certain rights in this invention.

### FIELD OF THE INVENTION

Embodiments of the present invention generally relate to lifelong learning machines and more specifically to a method, apparatus and system for a modular lifelong reinforcement leaning components framework.

### BACKGROUND OF THE INVENTION

Machine learning-based Artificial and Robotic Systems generally follow the process of training once on a large set of data and then are deployed and rarely updated. In order to improve these systems (e.g., as additional training data is collected or as the system needs to adapt to new tasks), they need to be fine-tuned or re-trained in an expensive, offline manner. In contrast, humans and animals continue to learn new concepts and evolve their skillsets as they act within and interact with novel environments over long lifespans. That is, biological systems demonstrate the ability to continuously acquire, fine-tune, and adequately reuse skills in novel combinations in order to solve novel yet structurally-related problems.

As Artificial and Robotic Systems are increasingly deployed and relied upon for mission-critical real-world applications, it is increasingly important that such systems exhibit similar capabilities as the biological systems and are able to continually learn and adapt in dynamically-changing environments, truly becoming Lifelong Learning Machines. Such continual/lifelong learning (LL) involves minimizing catastrophic forgetting of old tasks while maximizing a model's capability to learn new tasks.

While a lot of progress on continual learning for the incremental classification task has been made, it is much more challenging to do continual learning in a reinforcement learning setting, and research on lifelong reinforcement learning (L2RL) is still in its infancy.

Hence, there is a need for a highly configurable, modular, and extendable framework targeting the L2RL domain.

### SUMMARY OF THE INVENTION

Embodiments of the present principles provide methods, apparatuses and systems for a lifelong reinforcement leaning components framework.

In some embodiments, a method for lifelong reinforcement leaning includes receiving task features of a task to be performed, communicating the task features to a learning system, the wherein learning system learns and/or performs a task related to the received task features based on learning and/or performing similar previous tasks, determining from the received task features if the task related to the received task features has changed, if the task has changed, the task features of the changed task are communicated to the learning system, wherein the learning system learns and/or performs the changed task related to the received task features based on learning and/or performing similar previous tasks, at least one of automatically annotating or automatically storing feature characteristics of received task features including differences between the features of the original task and the features of the changed task to enable the learning system to more efficiently learn and/or perform at least the changed task, and if the task has not changed, processing the task features of a current task by the learning system to learn and/or perform the current task.

In some embodiments, an apparatus for lifelong reinforcement learning includes a processor and a memory accessible to the processor, the memory having stored therein at least one of programs or instructions executable by the processor to configure the apparatus to receive task features of a task to be performed, communicate the task features to a learning system, wherein the learning system learns and/or performs a task related to the received task features based on learning and/or performing similar previous tasks, determine from the received task features if the task related to the received task features has changed, if the task has changed, communicate the task features of the changed task to the learning system, wherein the learning system learns and/or performs the changed task related to the received task features based on learning and/or performing similar previous tasks, at least one of automatically annotate or automatically store feature characteristics of received task features, including differences between the features of the original task and the features of the changed task, to enable the learning system to more efficiently learn and/or perform at least the changed task, and if the task has not changed, process the task features of a current task by the learning system to learn and/or perform the current task.

In some embodiments, a system for lifelong reinforcement learning includes a pre-processor module, an annotator module, a learning system, and an apparatus including a processor and a memory accessible to the processor, the memory having stored therein at least one of programs or instructions executable by the processor to configure the apparatus to receive, at the pre-processor module, task features of a task to be performed, communicate, using the pre-processor module, the task features to a learning system, wherein the learning system learns and/or performs a task related to the received task features based on learning and/or performing similar previous tasks, determine from the received task features, using the pre-processor module, if the task related to the received task features has changed, if the task has changed, communicate the task features of the changed task from the pre-processor module to the learning system, wherein the learning system learns and/or performs the changed task related to the received task features based on learning and/or performing similar previous tasks, at least one of automatically annotate or automatically store, using the annotator module, feature characteristics of received task features, including differences between the features of the original task and the features of the changed task, to the learning system to more efficiently learn and/or perform at least the changed task, and if the task has not changed, process the task features of a current task by the learning system to learn and/or perform the current task.

Various advantages, aspects and features of the present disclosure, as well as details of an illustrated embodiment thereof, are more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a high-level block diagram of a Lifelong Reinforcement Learning Components Framework (L2RLCF) system in accordance with an embodiment of the present principles.

FIG. 2 depicts a Table of learning results of the L2RLCF system of FIG. 1 in accordance with an embodiment of the present principles.

FIG. 3 depicts a flow diagram of a method for lifelong reinforcement learning in accordance with an embodiment of the present principles.

FIG. 4 depicts a high-level block diagram of an embodiment of a computing device suitable for use with embodiments of a L2RLCF system of the present principles.

FIG. 5 depicts a high-level block diagram of a network in which embodiments of a L2RLCF system in accordance with the present principles can be implemented.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for providing a Lifelong Reinforcement Learning Components Framework (L2RLCF) system. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific components unified with a lifelong learning system, embodiments of the present principles can be implemented using other components in the L2RLCF system for providing continual, lifelong learning in accordance with the present principles. More specifically, a L2RLCF system of the present principles can include any component capable of conditioning data/task features that when communicated to a learning system, such as a lifelong learning system, enables the lifelong learning system to learn or perform tasks more efficiently, for example, in dynamically-changing environments.

In some embodiments of the present principles, learning or performing tasks more efficiently can include at least an L2RLCF system having lower sample complexity, for example, learning or performing tasks with a reduced number of interaction steps when compared to a typical lifelong learning system. Furthermore, learning or performing tasks more efficiently can come as a result of components such as different Preprocessors and Annotators of an L2RLCF system of the present principles helping the model to learn faster by, for example, conditioning (e.g., weighting, compressing, etc.) and adding metadata to received data. For example, in some embodiments, a pre-processor module of the present principles can include a pre-trained or actively updated machine learning model to be able to determine from task features when a task being processed has changed. In addition, in some embodiments a pre-processor module of the present principles can weight data, such as task features, to prioritize and reduce data/features to be processed and/or to score given states, such as an estimated level of danger of a given state, which enables an L2RLCF system of the present principles to learn or perform a task more efficiently when compared to a stat of the art learning system.

Lifelong Reinforcement Learning (LRL) involves training an agent to maximize its cumulative performance on a stream of changing tasks over a long lifetime. LRL agents must balance plasticity vs. stability: learning the current task while maintaining performance on previous tasks. One approach to meet the challenges of deep LRL is by careful managing the agent's learning experiences, in order to learn (without forgetting) and build internal meta-models (of the tasks, environments, agents, and world). One strategy for managing experiences is to recall data from previous tasks and mix it with data from the current task when training. Some embodiments of the present principles include the pre-processing of environmental features and the annotation of features/process changes to enable an LRL system to learn more efficiently, for example, in dynamically-changing environments.

Embodiments of the present principles provide a Lifelong Reinforcement Learning Components Framework (L2RLCF) system, which assimilates different components, which are directed to different aspects of the continual, lifelong learning problem, with a lifelong reinforcement learning (L2RL) system into a unified system. Embodiments of the present principles further include a novel API enabling easy integration of novel lifelong learning components.

Embodiments of a L2RLCF system of the present principles can integrate multiple lifelong learning algorithms and can include an API in a fully-realized real-world system, which can include at least some of the following algorithmic components and functions:
a base system for L2RL based on generative replay in a wake/sleep setting;
the automatic triggering of sleep via changepoint detection;
the compression of experiences in the replay buffer;
task-specific prioritized replay mechanism for dangerous state detection;
Representation learning from RGB-observations via self-supervised learning.

It should be noted that embodiments of a L2RLCF system of the present principles are not limited to the above-described components and functionalities. Embodiments of the present principles can be implemented with any lifelong learning algorithm that can be integrated within a wake-sleep mechanism. Embodiments of a L2RLCF system of the present principles recall data from previous tasks and mix such data with data from a current task during training.

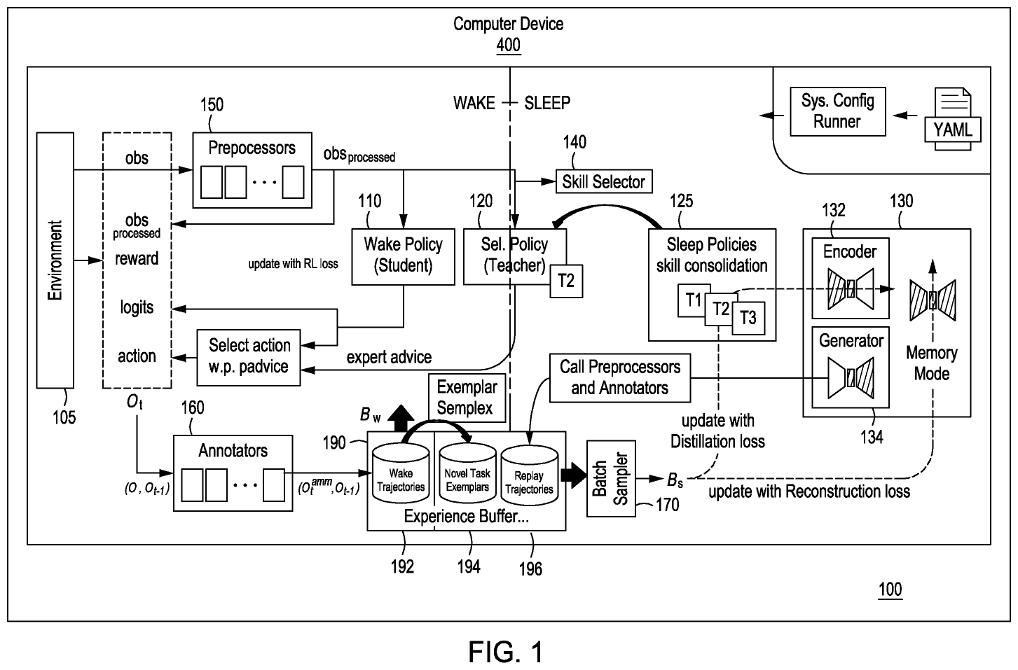

FIG. 1 depicts a high-level block diagram of a Lifelong Reinforcement Learning Components Framework (L2RLCF) system 100 in accordance with an embodiment of the present principles. The L2RLCF system 100 of FIG. 1 illustratively comprises a wake policy module 110, an optional expert advice policy module 120, a sleep policy module 125, a memory module 130, a skill selector module 140, a pre-processor module 150, an annotator module 160, a batch sampler module 170, an optional system configuration runner module 180 and an experience buffer 190. Although the L2RLCF system 100 of FIG. 1 depicts specific components directed to different aspects of the continual, lifelong learning problem, alternate embodiments of the present principles can include different or more or less components. For example, in some embodiments of the present principles, the optional system configuration runner module 180 and the optional expert advice policy module 120 can comprise separate components, not part of the L2RLCF system 100 of FIG. 1. As depicted in FIG. 1, embodiments of a L2RLCF system of the present principles, such as the L2RLCF system 100 of FIG. 1, can be implemented in a computing device 400 (described in greater detail below).

Embodiments of a L2RLCF system of the present principles, such as the L2RLCF SYSTEM 100 of FIG. 1, implement a wake-sleep learning process (fast and slow, respectively) that directly tackles the tradeoff in lifelong learning between plasticity, for example learning the current task, and stability, for example remembering past tasks. That is, the lifelong learning technique of the L2RLCF system 100 of FIG. 1 can consist of two phases: i) a wake phase in which standard learners learn aspects of the current task using, for example, a Markov decision process (MDP) reward and dynamics process, and ii) a sleep phase in which learned knowledge is consolidated across multiple wake periods. In some embodiments of the present principles, the wake policy module 110, the expert advice policy module 120, the sleep policy module 125, the memory module 130 and the skill selector module 140 comprise a learning system such as a lifelong learning (LL) system 102.

In addition, in some embodiments of the present principles, the components of a L2RLCF system of the present principles, such as the L2RLCF system 100 of FIG. 1, can comprise lifelong learning systems and/or comprise individual lifelong learning systems such that any actions performed by an individual component can be learned over time and such knowledge of previously performed actions can be applied to the performance of current or future actions to be performed. For example, in some embodiments of the present principles, the pre-processor module 150 can include a lifelong learning system (not shown) such that any actions performed by the pre-processor module can be learned over time and such knowledge of previously performed actions can be applied to the performance of current or future actions to be performed. Similarly, in some embodiments, the annotator module 160 can include a lifelong learning system (not shown) such that any actions performed by the annotator module 160 can be learned over time and such knowledge of previously performed actions can be applied to the performance of current or future actions to be performed.

In the L2RLCF system 100 of FIG. 1, the environment 105 can include any Partially Observable Markov Decision Process (POMDP) in which an agent can perceive observations, interact with the environment, and receive a reward for actions taken. That is, in lifelong reinforced learning (LRL) instances, each task is a Markov decision process (MDP), and the agent must learn a policy for interacting with its environment to maximize the agent's lifetime performance (e.g., average reward over all tasks). A lifelong RL syllabus is a sequence of tasks that the learning agent experiences one at a time for a fixed number of interactions. In some embodiments, each task can be assumed to be formulated as a Partially Observable Markov Decision Processes (POMDPs), in which each POMDP is defined by a tuple. In single-task RL, an objective is to learn a policy that maps the history of observations to actions, such that the policy maximizes the expected discounted future reward. The task-optimal policy is referred to as a single task expert (STE).

Given a syllabus, an environment can contain alternate runs including evaluation blocks (EBs) and learning blocks (LBs). A task is considered to be seen with respect to an EB if the task has appeared in any LB preceding it, otherwise the task is considered unseen. During each EB, the average accumulated reward of the agent is evaluated on all tasks in the syllabus (including unseen tasks). During each LB, the agent can learn on a single task for a fixed number of interactions. The STE for each task serves as a baseline and measures the relative performance of the learner with respect to an asymptotic optimal.

The L2RLCF SYSTEM 100 of FIG. 1 can implement techniques for training machine learning systems for lifelong machine learning, such as described in commonly owned U.S. Pat. No. 11,494,597 issued on Nov. 8, 2022, which is incorporated herein by reference in its entirety. That is, embodiments of the present principles can implement generative replay, which is a biologically-inspired replay mechanism that augments learning experiences with self-labelled examples drawn from an internal generative model trained to approximate the distribution of past experiences. Data sampled by this generator model (e.g., memory) can be pseudo-labeled or self-labeled to generate paired training examples that can reflect previously trained tasks.

In the L2RLCF system 100 of FIG. 1, the system configuration runner (SCR) module 180 is implemented to instantiate the sequence of tasks. That is, the SCR module 180 of FIG. 1 takes a configuration of task orderings with the length of each learning and evaluation period and automatically generates a sequence of simulators, in some embodiments, parallelizing individual episodes within each learning phase.

In the L2RLCF system 100 of FIG. 1, the SCR module 180 can spin off the L2RLCF system 100 system using a configuration file, such as from a yet another markup language (YAML) configuration, which contains all of the information needed to instantiate and run the L2RLCF system 100. The SCR module 180 enables iteration over multiple experiment settings and can include at least the following abilities:
The SCR module 180 can set system parameters through a YAML configuration and also as argparse settings.
The SCR module 180 can recursively loop through the YAML configuration to load functors and instantiate class objects, removing the constraint that class arguments are restricted to Built-In types, giving the L2RLCF system 100 the ability to hierarchically load objects, and allowing for custom parameters and custom class objects.
The SCR module 180 can set system environment variables which might be required by environment simulators or by other components where parameter passing through object initiation is not possible.
The SCR module 180 can enable configuration templating. That is, in an the L2RLCF system of the present principles, such as the L2RLCF system 100 of FIG. 1, many parameters, like learning block size or observation-actions space dimension, are relevant to multiple components. The template section of the configuration enables parameters (including assigning functors or instantiating shared class objects) to be set and have the parameters available across multiple components.
The SCR module 180 can assist with scheduling of components to specific GPU IDs.

In the L2RLCF system 100 of FIG. 1, the pre-processor module 150 comprises a list of pre-processor objects. In some embodiments, each pre-processor object is implemented when an agent perceives/receives an observation. That is, each preprocessor is passed observation features from, for example, sensors implemented by agents, and subsequently transforms the features into a useable form (e.g., converting RGB features to features usable by later machine learning algorithms). In general, a pre-processor module of the present principles, such as the pre-processor module 150 of the L2RLCF system 100 of FIG. 1, pre-processes input data, such as task features, to enable an LRL learning system of the L2RLCF system of the present principles to learn more efficiently, for example, in dynamically-changing environments. For example, in some embodiments, a pre-processor module of the present principles can include a pre-trained machine learning model to be able to determine from task features when a task being processed has changed. In addition, in some embodiments a pre-processor module of the present principles can weight data, such as task features, to prioritize data/features to be processed and/or to score given states, such as an estimated level of danger of a given state.

In accordance with the present principles, once the observations are pre-processed, they are added to the original observations as named tuples. The tuples of pre-processed features can be implemented by system components (described in greater detail below). In some embodiments of the present principles, pre-processors of the pre-processor module 150 can also be implemented to detect changes in a task being performed by an L2RLCF system of the present principles, such as the L2RLCF system 100 of FIG. 1 (e.g., by evaluating received task features). When such change in a task is detected, the pre-processor module 150 can trigger a wake mode, which can implement, for example, self-supervised learning for learning the new task using at least some knowledge of previously learned tasks. That is, in some embodiments, when the pre-processor module 150 detects a change in task, the pre-processor module 150 can communicate the task features to a learning system, such as the lifelong learning system 102 of the L2RLCF system 100 of FIG. 1. The task features of the changed task are communicated to the learning system 102 in which actions for performing previously learned tasks similar to the changed task are applied to the received task features to perform the changed task.

In the L2RLCF system 100 of FIG. 1, the annotator module 160 can include annotator objects. In some embodiments, the annotator module 160 can be implemented to automatically annotate, without the need for user intervention, for example using meta data, data characteristics and/or task features, and/or changes in such features, and the like, after an agent has stepped through an action and received a reward. In some embodiments, a respective tuple (observation at a previous time step obs_{processed}, wake policy logits, action, reward) can be passed to each annotator object, which is then queried for the annotation feature. In general, an annotator module of the present principles, such as the annotator module 160 of the L2RLCF system 100 of FIG. 1, can automatically annotate data/feature characteristics using, for example meta data, to note data/feature changes, data/feature characteristics, or other data-related parameters such as task changes, that can be used to enable an LRL learning system of the L2RLCF system of the present principles to learn or perform tasks more efficiently, for example, in dynamically-changing environments. In embodiments of the present principles, the annotations, when communicated to an LRL learning system of the L2RLCF system of the present principles, can enable the LRL learning system to learn tasks/processes associated and/or related to changed features/tasks. As such, when such changed features/tasks are subsequently communicated to the LRL learning system, the LRL learning system will know how to at least one of learn and or perform the changed features/tasks based on having previously learned and/or performed the changed features/tasks.

For example, in some embodiments, using previous observations, the annotator objects of the annotator module 160 can create prioritized replay buffers by annotating data/features that have been weighted (described in greater detail below). In an experimental example described below (i.e., the Starcraft-2 case study), the annotator objects of the annotator module 160 can be used for “danger detection”, which can include annotating the scoring of an estimated level of danger of a given state, and then building a replay buffer of safe states to promote a useful bias in the policy. In some embodiments, as with the pre-processor objects of the pre-processor module 150, the annotator objects of the annotator module 160, features are added as a named tuple. In some embodiments, the annotators of the annotator module 160 are implemented to annotate similarities and differences between a current task and previously performed tasks such that the learning of a new task does not have to begin without any knowledge. For example, in some embodiments in which a task change has been identified, the annotator module 160 can annotate and/or store the differences between a previous task and the changed task. In some embodiments, the annotated and/or stored differences can be used by, for example, the learning system 102 to at least one of learn or perform subsequent tasks.

The memory module 130 of the L2RLCF system 100 of FIG. 1 can comprise a generic memory model including different styles of replay (e.g., experience replay, generative replay), and in some embodiments can include more complex models such as clustering-based hierarchical memory models. In some embodiments of the present principles, the memory module 130 can include a generator model, described above.

In the embodiment of FIG. 1, the memory module 130 includes an encoder 132 and a decoder 134. The encoder can be implemented to map observations to a vector-valued latent space. In some embodiments of the present principles, the encoder 132 is not a necessity as some memory modules 130 do not require encoding (e.g., experience replay).

The decoder 134 of the memory module 130 is trained to reconstruct the original input. In some embodiments, the decoder 134 can include generative models/memory (e.g., variational autoencoders) to sample novel experiences. In some embodiments, the decoder can provide a mechanism to sample old experiences stored in a buffer, for example, by returning exemplars. In embodiments in which a generative model/memory is used, the generative model/memory can be updated via a reconstruction loss comparing raw observations to reconstructed observations or comparing some pre-processed features to reconstructed versions of those features.

In the embodiment of the L2RLCF system 100 of FIG. 1, the wake policy module 110 can comprise an RL learner, which determines the actions an agent should take in a dynamic environment in order to maximize a cumulative reward. In some embodiments, during a wake phase, a plastic wake policy, π_{w}, for the wake policy module 110 is optimized for a current task by interacting with the environment and using the RL learner. In some embodiments, transition tuples are collected during training and stored in a buffer; each tuple contains (o, r, a), the observation, o, the reward for the previous action, r, and the policy output, a, (e.g., the policy logits or one-hot encoded action). A sleep policy, πₛ, of the sleep policy module 125 provides “advice” (i.e., with importance decaying over time) in order to encourage the RL learner of the sleep policy module 125 to begin exploring the current task using the consolidated policy learned from all previous tasks to encourage faster adaptation to the new task.

In the embodiment of the L2RLCF system 100 of FIG. 1, the sleep policy module 125 can comprise a different instantiation of a same RL learner as the wake policy module 110 and can serve as a method of consolidating skills across multiple wake-sleep cycles. The sleep policy module 125 is configured to replay old experiences (e.g., past samples, exemplars, generated samples, etc.) to help minimize catastrophic forgetting and to learn to generalize unseen tasks. In the sleep policy module 125, sleep policies can be updated (i.e., skill consolidation) using a distillation loss encouraging the sleep policy module 125 to imitate the observation, action logit pairs collected by the wake policy module 110 as well as observation, action logit pairs sampled from various replay buffers. In some embodiments during a sleep phase, a stable sleep policy, πₛ, is optimized to maximize the incorporation of new knowledge (i.e., the action selection in the wake buffer) while minimally forgetting current knowledge. While not a general requirement of the wake-sleep mechanism, in some embodiments of wake-sleep used in the present principles, an additional replay type akin to generative replay in supervised learning can be implemented. Augmented dataset(s) can be created by combining wake transitions with tuples from a generative model, gₛ, which generates observations that are subsequently pseudo-labelled by the previous sleep policy. In such embodiments, the sleep policy and the generative model can be jointly trained.

In some embodiments of the present principles, a sleep phase can be triggered after a fixed number of interactions with the environment. However, triggering a sleep phase adaptively, at opportune times, can lead to better performance with less overhead. In such embodiments, an unsupervised change-point detection method can be applied to features extracted, for example, from Starcraft-2 observations, using a pre-trained model, such as a pretrained VGG-16 model because (a) an L2RLCF system of the present principles, such as the L2RLCF system 100 of FIG. 1, does not assume knowledge of task change points, and (b) sleep can be beneficial even when the task has not changed (i.e. a significant change in the policy can cause it to visit novel states and observations). In principle, in some embodiments change point detection can be applied to episodic reward as well.

In the embodiment of the L2RLCF system 100 of FIG. 1, the experience buffer 190 can include several different sampling mechanisms and illustratively includes a wake buffer 192, a novel task buffer 194, and a replay buffer 196. The wake buffer 192 of the experience buffer 190 can store information regarding current interactions after passing through annotators of the annotator module 160 and pre-processors of the processor module 150. The policy logits are stored in the wake buffer 192 along with the observations, rewards, actions taken, and other meta-data. The observations stored in the wake buffer 192 can be stored sequentially to create trajectories. In some embodiments, when the wake buffer 192 becomes full, the information stored in the wake buffer 192 can be sampled and used for training the wake policy module 110.

The exemplar buffer 194 of the experience buffer 190 can select information to store via at least one of a random sampling of a current wake buffer 192, importance sampling, via clustering of data samples, or via other learning techniques.

The replay buffer 196 of the experience buffer 190 of the L2RLCF system 100 of FIG. 1, can be implemented for training the memory module 130 and skill consolidation by dynamically generating replay samples. In some embodiments, transitions can be stored in the replay buffer 196 in a highly compressed form. Compression enables a buffer of a given size to contain a larger number of transitions, increasing the chance of retaining diverse examples from different tasks. That is, in some embodiments, information regarding an agent's observations, including but no limited to task transitions, task feature characteristics and/or changes, and the like, can be compressed before they are stored in the replay buffer 196, enabling a L2RLCF of the present principles, such as the L2RLCF system 100 of FIG. 1, to store more samples. In some embodiments, the agent observations can be imagelike float32 tensors with 3 channels, and thus each pixel occupies 96 bits. In the compressed observation, each pixel is quantized to an 8-bit integer, a 24× reduction in size.

In the embodiment of the L2RLCF system 100 of FIG. 1, the batch sampler 170 can be implemented as at least one of a random/equal weight sampler or a prioritized replay sampler, which we can be implemented for danger detection, which is described in more detail with respect to an experimental example described below.

As described above, various components of a L2RLCF of the present principles, such as the L2RLCF system 100 of FIG. 1, can be trained following a Student-Teacher Learning process. Closely tied to the Student-Teacher Learning is expert advice and skill selection. In the embodiment of the L2RLCF system 100 of FIG. 1, the expert advice policy module 120 can define a mixture probability, padvice, that can inform an agent whether to use a current wake policy to process a current observation or whether to use the policy of an expert teacher, which is generally defined by the sleep policy module 125.

In some embodiments, for a first wake phase, no advice is taken. In subsequent wake phases, the expert advice policy module 120 can sample from the sleep policy module 125 and can do so with decaying probability over time. A goal of this process is that the wake policy module 110 will be encouraged to explore in a more intelligent way if there is positive forward transfer between the tasks the sleep policy module 125 has stored/seen and the current task, which ultimately teaches the wake policy module 110 more effective wake policies. In some embodiments, a probability for the expert advice policy module 120 can be set using an advice scheduler (not shown), which can be highly configurable (e.g., constant, linearly decaying, exponentially decaying, cyclic).

In some embodiments, the sleep policy module 125 can include multiple sub-policies, for example if there exists a mixture of experts. In such embodiments of a L2RLCF of the present principles, such as the L2RLCF system 100 of FIG. 1, the skill selector 140 can select which policy should be implemented at the start of a wake phase. In such embodiments, a buffer of observations can be tested across multiple sleep policies. The policy which yields the highest reward can be selected to act as a teacher network for the wake policy of the wake policy module 110. Alternatively or in addition, in some embodiments, the weights of a best sleep policy of the sleep policy module 125 can be copied directly to a wake policy of the wake policy module 110 for strong initialization of a wake model for a current task, promoting strong forward transfer (i.e., the system is using the current best known policy for the given task, similar to the jump start provided by advice).

In an experimental evaluation example, different lifelong learning scenarios (sequences of tasks) were implemented consisting of Starcraft-2 minigames. Starcraft-2 is a real-time strategy game in which a player must manage multiple units in combat, collection, and construction tasks to defeat an enemy opponent. In the evaluation environment, the RL agent has control over selecting units and directing the actions the unit should take to accomplish a given task. In this setting, the L2RLCF of the present principles, such as the L2RLCF system 100 of FIG. 1, had to learn to solve one task at a time without forgetting previous tasks, and the performance of the agent was measured on all tasks immediately after learning a task. In the example, three minigames were selected with two variants each as the task set. In the experimental evaluation example, each task involved either i) combat between different unit types or ii) resource collection (CollectMineralShards). In the experimental evaluation example, the tasks included:
Collecting Mineral Shards—No Fog of War: A map with 2 Marines and an endless supply of Mineral Shards. Rewards are earned by moving the Marines to collect the Mineral Shards. Whenever all 20 Mineral Shards have been collected, a new set of 20 Mineral Shards are spawned at random locations (at least 2 units away from all Marines). Fog of war is disabled.
Collecting Mineral Shards—Fog of war: A map with 2 Marines and an endless supply of Mineral Shards. Rewards are earned by moving the Marines to collect the Mineral Shards. Whenever all 20 Mineral Shards have been collected, a new set of 20 Mineral Shards are spawned at random locations (at least 2 units away from all Marines). Fog of war is enabled, meaning the agent must be able to learn without full knowledge of the current state of the environment.
Defeating Zerglings And Banelings—One Group: A map with 9 Marines on the opposite side from a group of 6 Zerglings and 4 Banelings. Rewards are earned by using the Marines to defeat Zerglings and Banelings. Whenever all Zerglings and Banelings have been defeated, a new group of 6 Zerglings and 4 Banelings is spawned, and the player is awarded 4 additional Marines at full health, with all other surviving Marines retaining their existing health (no restore). Whenever new units are spawned, all unit positions are reset to opposite sides of the map.
Defeating Zerglings And Banelings—Two Groups: A map with 9 Marines in the center with 2 groups consisting of 9 Zerglings on one side and 6 Banelings on the other side. Rewards are earned by using the Marines to defeat Zerglings and Banelings. Whenever a group has been defeated, a new group of 9 Zerglings and 6 Banelings is spawned and the player is awarded 6 additional Marines at full health, with all other surviving Marines retaining their existing health (no restore). Whenever new units are spawned, all unit positions are reset to opposite sides of the map.
Defeating Roaches—One Group: A map with 9 Marines and a group of 4 Roaches on opposite sides. Rewards are earned by using the Marines to defeat Roaches. Whenever all 4 Roaches have been defeated, a new group of 4 Roaches is spawned and the player is awarded 5 additional Marines at full health, with all other surviving Marines retaining their existing health (no restore). Whenever new units are spawned, all unit positions are reset to opposite sides of the map.
Defeating Roaches—Two Groups: A map with 9 Marines in the center and 2 groups consisting of 6 total Roaches on opposite sides (3 on each side). Rewards are earned by using the Marines to defeat Roaches. Whenever all 6 Roaches have been defeated, a new group of 6 Roaches is spawned and the player is awarded 7 additional Marines at full health, with all other surviving Marines retaining their existing health (no restore). Whenever new units are spawned, all unit position are reset to starting areas of the map.

In the experimental evaluation example, PySC2 was used to interface with Starcraft-2. For the hand-crafted observation space, a subset of the available observation maps were used: the unit type, selection status, and unit density two-dimensional observations. The action space was factored into functions and arguments, such as move (x,y) or stop ( ). The agent received positive rewards for collecting resources and defeating enemy units and negative rewards for losing friendly units. In the experimental evaluation example, syllabi consisting of alternating (two tasks, each seen three times) and condensed (all six tasks, each seen once) scenarios were considered.

To quantitatively evaluate the performance of an L2RLCF system of the present principles, such as the L2RLCF system 100 of FIG. 1, two sets of metrics were considered. First, it was considered how the rewards achieved by an agent compare to the “optimal” RL agent by comparing to the terminal performance of agents trained on each task to convergence (a “single task expert (STE)”). These metrics focus purely on understanding the dynamics of an agent at periodic evaluation blocks (EBs). Secondly, algorithms using lifelong learning metrics which take into account both behavior of the agent at periodic evaluation blocks and also characteristics of the agent as the agent learns, for example, during learning blocks “LBs” (i.e., learning curves during wake) were compared.

In the experimental evaluation example, the following variants of the RR metric were considered: Relative reward in the final EB (RR Ω), which measures how well the agent performs on all tasks after completing the syllabi: Relative reward on known tasks (RRσ), which measures how well the agent performs on previously seen tasks (quantifies forgetting/backward transfer: and Relative reward on unknown tasks (RRκ), which measures how well the agent generalizes/transfers knowledge from seen to unseen tasks. Note that in all cases, more-positive values are better for all metrics.

In the experimental evaluation example, the following lifelong learning metrics were further considered: Forward Transfer Ratio (FTR), which measures knowledge transfer to unknown tasks: Backward Transfer Ratio (BTR), which measures knowledge transfer to known tasks. A value greater than one indicates positive transfer: Relative Performance (RP), which compares the learning curves between the lifelong learner and a single task learner. A value greater than one indicates either faster learning by the lifelong learner and/or superior asymptotic performance: and Performance Maintenance (PM), which measures catastrophic forgetting over the entire syllabus. A value less than 0 indicates forgetting.

In the experimental evaluation example, the batch sampler 170 was implemented as a prioritized replay sampler for danger detection based on detecting dead-end (dangerous) states. It was determined that increasing the lifetime of an agent by avoiding dead end states is a useful bias. The batch sampler 170 can implement a Danger Detector, which outputs a “danger score” of how likely the agent is to lose the battle from a given state. This score is used as a replay priority. In some embodiments, a Deep Streaming Linear Discriminant Analysis (DeepSLDA) can be implemented as a danger detector. Deep SLDA works on top of a fixed feature extractor, which can be trained based on a FullyConv architecture using data generated from single task experts (agents trained to convergence using a standard RL algorithm for a single task). In some embodiments, a danger detector of the present principles can be integrated as an annotator block of the annotator module 160. The danger detector can annotate the observations on the likelihood of if the state is dangerous; by following safe policies during wake and biasing the data collection process, which amounts to a form of prioritized replay used during the sleep phase's memory consolidation.

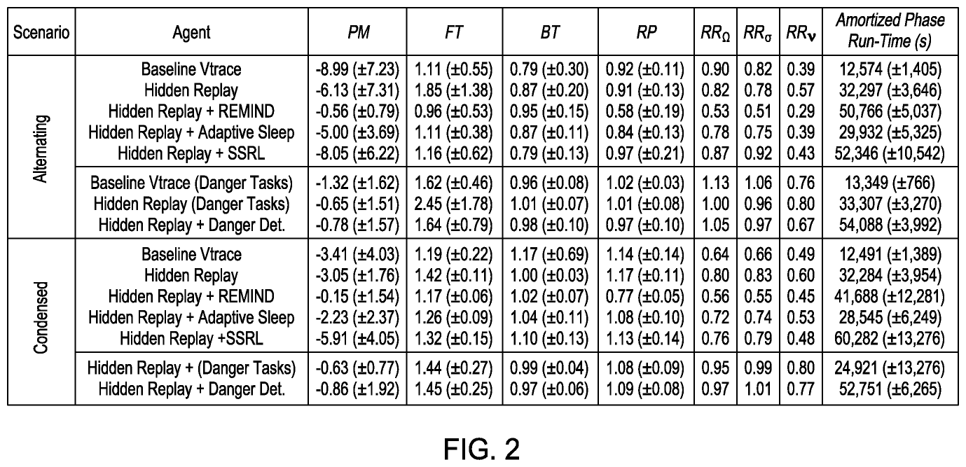

The experimental evaluation example was implemented for evaluating the components of an L2RLCF system of the present principles, such as the L2RLCF system 100 of FIG. 1, using standardized sets of syllabi for different scenarios under identical wake/sleep conditions with the same base agent. All the experiments were run with the wake module interacting with 8 Starcraft-2 simulators. Each wake phase had 2 million interaction steps with 2 forced sleep phases in between. For experiments involving adaptive sleep, the number of sleep phases in a given learning block is dynamic. FIG. 2 depicts a Table 200 of learning results of the L2RLCF system 100 of FIG. 1 as specific components are turned on and off. More specifically, the Table 200 of FIG. 2 depicts an ablation study, in which different submodules of an L2RLCF system of the present principles are turned on and off to understand how the lifelong learning performance is affected under different configurations of the L2RLCF system and to show improvement in utility as different modules are added. As depicted in the Table 200 of FIG. 2, in some embodiments compressing the replay can negatively affect the performance of the L2RLCF system 100 system in terms of rewards compared to the single task expert in most cases, and oppositely, self-supervised learning generally helps with respect to performance relative to the single task expert. Similarly, the Table 200 of FIG. 2 depicts that adaptive sleep of the present principles can improve performance. The amortized phase run-times, in seconds, are reported in the Table 200 of FIG. 2 along with performance metrics. In general and as seen from the Table 200 of FIG. 2, adding different components increases the run-time for each phase, but the learners become more sample efficient, for example, requiring about 2 million steps to learn a given task as opposed to about 10 million steps needed for single task experts.

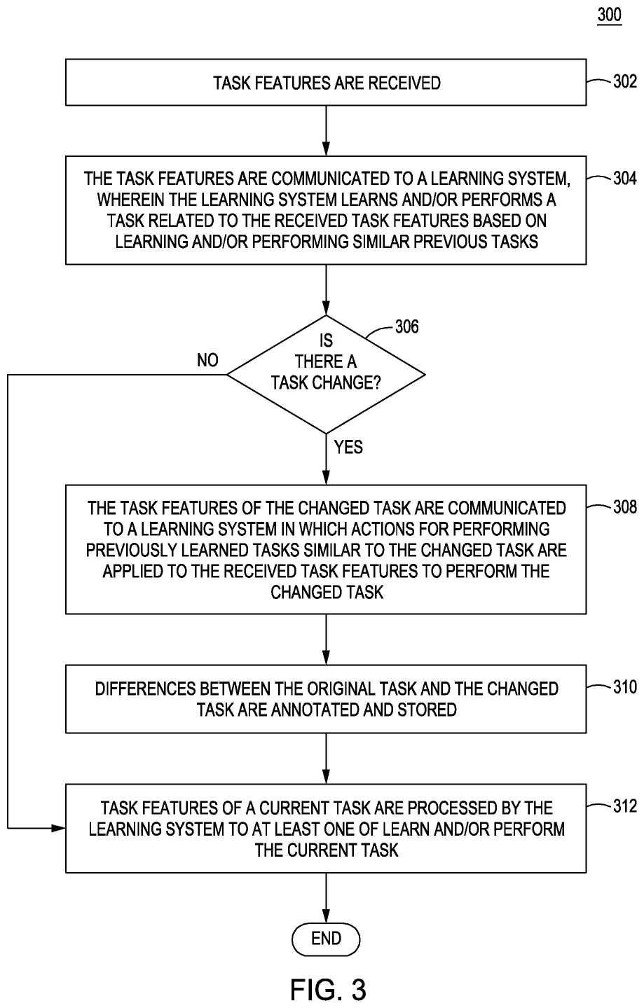

FIG. 3 depicts a flow diagram of a method 300 for lifelong reinforcement learning in accordance with an embodiment of the present principles. The method 300 can begin at 302 during which task features of a task to be performed are received. The method 300 can proceed to 304.

At 304, the task features are communicated to a learning system, where the learning system learns and/or performs a task related to the received task features based on learning and/or performing similar previous tasks. The method 300 can proceed to 306.

At 306, it is determined from received task features if a task related to received task features has changed. If it is determined that the task has changed the method can proceed to 308. If it is determined that the task has not changed the method can proceed to 312.

At 308, the task features of the changed task are communicated to the learning system, wherein the learning system learns and/or performs the changed task related to the received task features based on learning and/or performing similar previous tasks. The method 300 can proceed to 310.

At 310, feature characteristics of received task features, including differences between the features of the original task and the features of the changed task are at least one of automatically annotated or automatically stored to enable the learning system to more efficiently learn and/or perform at least the changed task. The method 300 can proceed to 312.

At 312, if the task has not changed, the task features of a current task are processed by the learning system to learn and/or perform the current task. The method 300 can be exited.

In some embodiments, the learning system of the present principles implements a wake or sleep learning process to learn and/or perform a task.

In some embodiments, the method can further include compressing stored information to enable more information to be stored.

In some embodiments, the learning system implements a generative model trained to at least approximate a distribution of the learning and/or performance of tasks.

In some embodiments, a sleep phase of a learning process of the learning system can be triggered based on the received task features.

In some embodiments, the received task features are pre-processed before communicating the task features to the learning system to configure the task features for use by the learning system. In such embodiments, the pre-processing can include at least one of weighting task features and training machine learning models to identify task changes based on the received task features.

In some embodiments, the annotated or stored differences are communicated to the learning system and used by the learning system to learn and/or perform subsequent tasks.

In some embodiments, an apparatus for lifelong reinforcement learning includes a processor and a memory accessible to the processor, the memory having stored therein at least one of programs or instructions executable by the processor to configure the apparatus to receive task features of a task to be performed, communicate the task features to a learning system, wherein the learning system learns and/or performs a task related to the received task features based on learning and/or performing similar previous tasks, determine from the received task features if the task related to the received task features has changed, if the task has changed, communicate the task features of the changed task to the learning system, wherein the learning system learns and/or performs the changed task related to the received task features based on learning and/or performing similar previous tasks, at least one of automatically annotate or automatically store feature characteristics of received task features, including differences between the features of the original task and the features of the changed task, to enable the learning system to more efficiently learn and/or perform at least the changed task, and if the task has not changed, process the task features of a current task by the learning system to learn and/or perform the current task.

In some embodiments, a system for lifelong reinforcement learning includes a pre-processor module, an annotator module, a learning system, and an apparatus including a processor and a memory accessible to the processor, the memory having stored therein at least one of programs or instructions executable by the processor to configure the apparatus to receive, at the pre-processor module, task features of a task to be performed, communicate, using the pre-processor module, the task features to a learning system, wherein the learning system learns and/or performs a task related to the received task features based on learning and/or performing similar previous tasks, determine from the received task features, using the pre-processor module, if the task related to the received task features has changed, if the task has changed, communicate the task features of the changed task from the pre-processor module to the learning system, wherein the learning system learns and/or performs the changed task related to the received task features based on learning and/or performing similar previous tasks, at least one of automatically annotate or automatically store, using the annotator module, feature characteristics of received task features, including differences between the features of the original task and the features of the changed task, to enable the learning system to more efficiently learn and/or perform at least the changed task, and if the task has not changed, process the task features of a current task by the learning system to learn and/or perform the current task.

In some embodiments, the learning system comprises at least one of a wake policy module, a sleep policy module, a memory module or a skill selector module and implements a wake-sleep learning process to learn and/or perform a task. In such embodiments, the memory module can implement a generative model trained to approximate a distribution of the learning and/or performance of tasks. In such embodiments, a sleep phase of the sleep policy module of the learning system is triggered based on the received task features.

In some embodiments, a system of the present principles can include a replay buffer in which stored information to be used by the learning system to learn and/or perform tasks is stored in a compressed form.

In some embodiments, the pre-processor module, the annotator module and the learning system of the system of the present principles comprise lifelong learning systems.

Embodiments of the present principles can be implemented in many real-world applications such as autonomous vehicles, service robots, medicine, and network security among many others, and could be a useful tool for minimizing model obsolescence and promoting fast model adaptation in dynamically-changing environments. For example, autonomous vehicles should adapt to changing conditions (e.g., weather, lighting) and should learn from their mistakes (e.g., accidents) in order to improve in terms of safety and utility over time. Similarly, caregiver/companion robots should learn to adapt to the needs of specific human patients/partners and systems for medical diagnosis and treatment planning need to adapt to novel conditions (e.g., new disease variants) as well as adapt to the current state of patients and their response to previous interventions. As previously recited, embodiments of the present principles can be implemented in network security systems, which must be able to protect against novel threats (e.g., new viruses, hacking efforts) in an expedient manner in order to minimize security breaches.

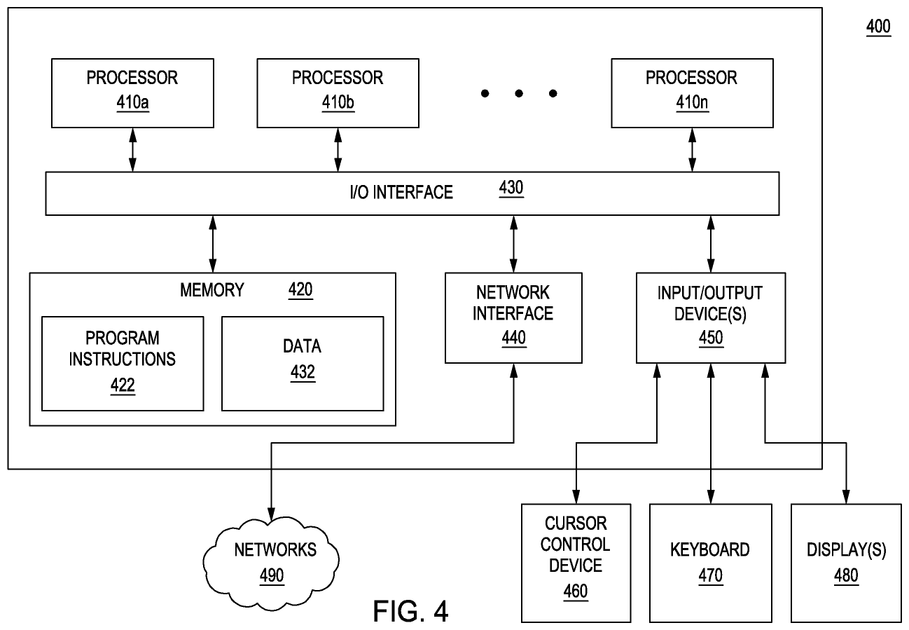

As depicted in FIG. 1, embodiments of a L2RLCF system of the present principles, such as the L2RLCF system 100 of FIG. 1, can be implemented in a computing device 400. For example, FIG. 4 depicts a high-level block diagram of a computing device 400 suitable for use with embodiments of an L2RLCF system of the present principles, such as the L2RLCF system 100 of FIG. 1. In the embodiment of FIG. 4, the computing device 400 includes one or more processors 410a-410n coupled to a system memory 420 via an input/output (I/O) interface 430. The computing device 400 further includes a network interface 440 coupled to I/O interface 430, and one or more input/output devices 450, such as cursor control device 460, keyboard 470, and display(s) 480. In various embodiments, a user interface can be generated and displayed on display 480. In some cases, it is contemplated that embodiments can be implemented using a single instance of a computing device 400, while in other embodiments multiple such systems, or multiple nodes making up the computing device 400, can be configured to host different portions or instances of various embodiments. For example, in one embodiment some elements can be implemented via one or more nodes of the computing device 400 that are distinct from those nodes implementing other elements. In another example, multiple nodes may implement the computing device 400 in a distributed manner.

In different embodiments, the computing device 400 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 400 can be a uniprocessor system including one processor 410, or a multiprocessor system including several processors 410 (e.g., two, four, eight, or another suitable number). Processors 410 can be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 can be configured to store program instructions 422 and/or, in some embodiments, machine learning systems that are accessible by the processor 410. In various embodiments, system memory 420 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 420. In other embodiments, program instructions and/or data can be received, sent or stored upon different types of computer-accessible media or on similar media separate from the system memory 420 or the computing device 400.

In one embodiment, I/O interface 430 can be configured to coordinate I/O traffic between processor 410, system memory 420, and any peripheral devices in the device, including network interface 440 or other peripheral interfaces, such as input/output devices 450. In some embodiments, I/O interface 430 can perform any necessary protocol, timing or other data transformations to convert data signals from one component (e.g., system memory 420) into a format suitable for use by another component (e.g., processor 410). In some embodiments, I/O interface 430 can include support for devices attached through various types of peripheral buses, such as a variant of the Peripheral Component Interconnect (PCI) bus standard or the Universal Serial Bus (USB) standard, for example. In some embodiments, the function of I/O interface 430 can be split into two or more separate components, such as a north bridge and a south bridge, for example. Also, in some embodiments some or all of the functionality of I/O interface 430, such as an interface to system memory 420, can be incorporated directly into processor 410.

Network interface 440 can be configured to allow data to be exchanged between the computing device 400 and other devices attached to a network (e.g., network 490), such as one or more external systems or between nodes of the computing device 400. In various embodiments, network 490 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 450 can, in some embodiments, include one or more display terminals, keyboards, keypads, touchpads, scanning devices, voice or optical recognition devices, or any other devices suitable for entering or accessing data by one or more computer systems. Multiple input/output devices 450 can be present in computer system or can be distributed on various nodes of the computing device 400. In some embodiments, similar input/output devices can be separate from the computing device 400 and can interact with one or more nodes of the computing device 400 through a wired or wireless connection, such as over network interface 440.

Those skilled in the art will appreciate that the computing device 400 is merely illustrative and is not intended to limit the scope of embodiments. In particular, the receiver/control unit and peripheral devices can include any combination of hardware or software that can perform the indicated functions of various embodiments, including computers, network devices, Internet appliances, PDAs, wireless phones, pagers, and the like. The computing device 400 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 400 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 400 can further include a web browser.

Although the computing device 400 is depicted as a general purpose computer, the computing device 400 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

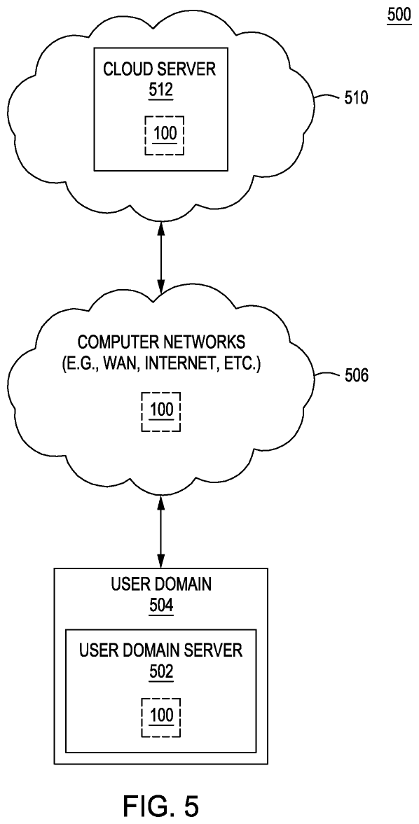

FIG. 5 depicts a high-level block diagram of a network in which embodiments of a L2RLCF system in accordance with the present principles, such as the L2RLCF system 100 of FIG. 1, can be implemented. The network environment 500 of FIG. 5 illustratively comprises a user domain 502 including a user domain server/computing device 504. The network environment 500 of FIG. 5 further comprises computer networks 506, and a cloud environment 510 including a cloud server/computing device 512.

In the network environment 500 of FIG. 5, an L2RLCF system in accordance with the present principles, such as the L2RLCF system 100 of FIG. 1, can be included in at least one of the user domain server/computing device 504, the computer networks 506, and the cloud server/computing device 512. That is, in some embodiments, a user can use a local server/computing device (e.g., the user domain server/computing device 504) to provide a lifelong learning system in accordance with the present principles. In some embodiments, a user can implement a L2RLCF system in accordance with the present principles, such as the L2RLCF system 100 of FIG. 1 in the computer networks 506 to provide lifelong learning in accordance with the present principles. Alternatively or in addition, in some embodiments, a user can provide a L2RLCF system of the present principles in the cloud server/computing device 512 of the cloud environment 1410. For example, in some embodiments it can be advantageous to perform processing functions of the present principles in the cloud environment 510 to take advantage of the processing capabilities and storage capabilities of the cloud environment 510.

In some embodiments in accordance with the present principles, a L2RLCF system in accordance with the present principles can be located in a single and/or multiple locations/servers/computers to perform all or portions of the herein described functionalities of a system in accordance with the present principles. For example, in some embodiments some components of a L2RLCF system of the present principles can be located in one or more than one of the user domain 502, the computer network environment 506, and the cloud environment 510 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from a computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

While the foregoing is directed to embodiments of the present principles, other and further embodiments of the invention can be devised without departing from the basic scope thereof, and the scope thereof is determined by the claims that follow.

1. A method for lifelong reinforcement learning, comprising:
receiving task features of a task to be performed;
communicating the task features to a learning system, wherein the learning system learns and/or performs a task related to the received task features based on learning and/or performing similar previous tasks;
determining from the received task features if the task related to the received task features has changed;
if the task has changed, communicating the task features of the changed task to the learning system, wherein the learning system learns and/or performs the changed task related to the received task features based on learning and/or performing similar previous tasks;
at least one of automatically annotating or automatically storing feature characteristics of received task features, including differences between the features of the original task and the features of the changed task, to enable the learning system to more efficiently learn and/or perform at least the changed task; and
if the task has not changed, processing the task features of a current task by the learning system to learn and/or perform the current task.

2. The method of claim 1, wherein the learning system implements a wake or sleep learning process to learn and/or perform a task.

3. The method of claim 1, further comprising compressing stored information to enable more information to be stored.

4. The method of claim 1, wherein the learning system implements a generative model trained to at least approximate a distribution of the learning and/or performance of tasks.

5. The method of claim 1, wherein a sleep phase of a learning process of the learning system is triggered based on the received task features.

6. The method of claim 1, wherein the received task features are pre-processed before communicating the task features to the learning system to configure the task features for use by the learning system.

7. The method of claim 6, wherein the pre-processing comprises at least one of weighting task features and training machine learning models to identify task changes based on the received task features.

8. The method of claim 1, wherein the annotated or stored differences are communicated to the learning system and used by the learning system to learn and/or perform subsequent tasks.

9. An apparatus for lifelong reinforcement learning, comprising:
a processor; and
a memory accessible to the processor, the memory having stored therein at least one of programs or instructions executable by the processor to configure the apparatus to:
receive task features of a task to be performed;
communicate the task features to a learning system, wherein the learning system learns and/or performs a task related to the received task features based on learning and/or performing similar previous tasks;
determine from the received task features if the task related to the received task features has changed;
if the task has changed, communicate the task features of the changed task to the learning system, wherein the learning system learns and/or performs the changed task related to the received task features based on learning and/or performing similar previous tasks;
at least one of automatically annotate or automatically store feature characteristics of received task features, including differences between the features of the original task and the features of the changed task, to enable the learning system to more efficiently learn and/or perform at least the changed task; and
if the task has not changed, process the task features of a current task by the learning system to learn and/or perform the current task.

10. The apparatus of claim 9, wherein the learning system implements a wake or sleep learning process to learn and/or perform a task.

11. The apparatus of claim 9, wherein the learning system implements a generative model trained to at least approximate a distribution of the learning and/or performance of tasks.

12. The apparatus of claim 9, wherein a sleep phase of a learning process of the learning system is triggered based on the received task features.

13. The apparatus of claim 9, wherein the received task features are pre-processed before communicating the task features to the learning system to configure the task features for use by the learning system.

14. The apparatus of claim 9, wherein the apparatus is further configured to communicate the annotated or stored differences to the learning system and the annotated or stored differences are used by the learning system to learn and/or perform subsequent tasks.

15. A system for lifelong reinforcement learning, comprising:
a pre-processor module;
an annotator module;
a learning system; and
an apparatus comprising a processor and a memory accessible to the processor, the memory having stored therein at least one of programs or instructions executable by the processor to configure the apparatus to:
receive, at the pre-processor module, task features of a task to be performed;
communicate, using the pre-processor module, the task features to a learning system, wherein the learning system learns and/or performs a task related to the received task features based on learning and/or performing similar previous tasks;
determine from the received task features, using the pre-processor module, if the task related to the received task features has changed;
if the task has changed, communicate the task features of the changed task, from the pre-processor module to the learning system, wherein the learning system learns and/or performs the changed task related to the received task features based on learning and/or performing similar previous tasks;
at least one of automatically annotate or automatically store, using the annotator module, feature characteristics of received task features, including differences between the features of the original task and the features of the changed task, to enable the learning system to more efficiently learn and/or perform at least the changed task; and
if the task has not changed, process the task features of a current task by the learning system to learn and/or perform the current task.

16. The system of claim 15, wherein the learning system comprises at least one of a wake policy module, a sleep policy module, a memory module or a skill selector module and implements a wake-sleep learning process to learn and/or perform a task.

17. The system of claim 16, wherein the memory module implements a generative model trained to approximate a distribution of the learning and/or performance of tasks

18. The system of claim 16, wherein a sleep phase of the sleep policy module of the learning system is triggered based on the received task features.

19. The system of claim 15, further comprising a replay buffer in which stored information to be used by the learning system to learn and/or perform tasks is stored in a compressed form.

20. The system of claim 15, wherein the pre-processor module, the annotator module and the learning system comprise lifelong learning systems.
